(19) United States
(12) Patent Application Publication
(10) Pub. No.: US 2003/0224723 A1
(43) Pub. Date: Dec. 4, 2003

(54) Method and system for providing two-way communication using an overlay of signals over a non-linear communications channel

(76) Inventors: Feng-Wen Sun, Germantown, MD (US); Neal Becker, Frederick, MD (US); Lin-Nan Lee, Potomac, MD (US); Khalid Karimullah, Olney, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/158,278

(22) Filed: May 30, 2002

(51) Int. Cl. H04B 7/185

(52) U.S. Cl. 455/12.1; 455/15

(57) ABSTRACT

An approach is provided for communicating in a radio communication system, such as a satellite network, wherein a terminal and a hub station communicates bi-directionally using a composite signal that is transmitted from a relay station and includes an inbound signal overlaid with an outbound signal. The hub station extracts the inbound signal from the composite signal by compensating for a non-linear effect (an optionally filter delay) associated with the composite signal.

### FIELD OF THE INVENTION

The present invention relates to a communications system, and more particularly to overlaying signals for bi-directional communication.

### BACKGROUND OF THE INVENTION

Modern satellite communication systems provide a pervasive and reliable infrastructure to distribute voice, data, and video signals for global exchange and broadcast of information. These satellite communication systems have emerged as a viable option to terrestrial communication systems. Unlike terrestrial networks, satellite communication systems are susceptible to service disruptions stemming from changing channel conditions, such as fading because of weather disturbances. Additionally, such systems cannot readily increase capacity as the number of satellite transponders is fixed. Further, channel interference constrains system capacity. As a result, efficient frequency reuse schemes are vital to the profitability of these satellite communication systems.

FIG. 12 is a diagram of a conventional satellite system in which inbound and outbound signals utilize unique frequency assignments. A two-way satellite system 1200 includes a hub station 1201 that transmits outbound signals to a satellite 1203 over a first carrier frequency, ƒ₁, and receives inbound signals from the satellite 1203 over a second carrier frequency, ƒ₂. Concurrently, the satellite 1203 can communicate with a remote satellite terminal 1205, which utilizes two other frequencies, ƒ₃, and ƒ₄, to transmit and receive, respectively. This arrangement is typical of a two-way satellite communication system, whereby the hub station 1201 transmits content to multiple Very Small Aperture Terminals (VSATs) 1205 (in which one is shown). The use of unique frequencies by the terminal 1205 and the hub station 1201 ensures that channel interference is minimized. The drawback, however, is that a large number of frequencies are required when terminals are added to the system 1200. As spectrum is a precious resource, it is vital to use the spectrum efficient.

An improvement to the system 1200 requires sharing of the satellite transponder for the inbound signals and the outbound signals. The efficiency of the spectrum sharing can be measured in the total throughput achieved by the inroute and outroute. Alternatively, if the outbound throughput is maintained at the same level as that of system without sharing the spectrum with the inroutes, the throughput achieved by the inbounds are gained by the system. Different schemes will yield different gains. In particular, when compared with prior art, significant gain can be realized by properly modeling and compensating the impact of the transmission channel. Conventional approaches simply assume that both inbounds and outbound share an ideal linear channel. As a result of this assumption, large uncompensated mutual interference exists between the inbound signals and the outbound signals.

Conventionally, to mitigate this mutual interference, spread spectrum techniques are utilized, wherein the average energy of the inbound signal is spread over a bandwidth that is much wider than the information bandwidth. Using spread spectrum transmission in the same transponder for both the inbound and outbound signals conserves space segment resources. However, transmitted power levels must be very low in order to minimize interference to the forward link; and as a result, spread spectrum techniques results in very limited capacity of each link, such that information bit rates on the return links tend to be low.

Furthermore, spread spectrum inbound signals are deployed to combat the channel impairments. A drawback with this approach is that overall system capacity is reduced. In addition, the impairments are greater if the inbound signals are Time Division Multiple Access (TDMA)-based instead of Code Division Multiple Access (CDMA)-based. In particular, it is recognized that the communication channels within the system 1200 may exhibit non-linear characteristics, notably from the amplifiers within the transponders. Conventional systems fail to compensate for this non-linear behavior. Further, the transponder introduces group delay stemming from a noise-limiting filter applied before the amplifier. The non-linear effects and the group delay impede performance of a shared transponder scheme. It is noted that, in general, a number of techniques exist for compensating non-linear effect of an amplifier. However, conventional techniques are not applicable to spectrum sharing. In the spectrum sharing situation, the impact of these channel impairment exhibits completely different natures. Such channel impairment needs to be compensated before the interference suppression techniques can be applied.

Based on the foregoing, there is a need for a radio communications system that enhances system capacity, while minimizing channel interference. There is also a need to minimize the effects of non-linearity of the communications channel. Therefore, an approach for efficiently providing frequency reuse is highly desirable.

### SUMMARY OF THE INVENTION

These and other needs are addressed by the present invention, wherein an approach is provided for extracting an inbound signal from a composite signal that includes the inbound signal overlaid with an outbound signal. A non-linearity compensation module determines the non-linear effect based on one of a pre-measurement of the non-linear effect and adaptively learning the non-linear effect from the received composite signal. The adaptive learning process can utilize at least one of curve fitting estimation and minimum mean squared estimation. A signal reconstruction module generates a reference signal representing the outbound signal. According to one embodiment of the present invention, the non-linearity compensation module modifies the reference signal based on the determined non-linear effect, and a group delay compensation module also modifies the reference signal for filter delay of the composite signal. Alternatively, the non-linearity compensation module can perform an inverse function to modify the composite signal based on the determined non-linear effect. In another embodiment of the present invention, the composite signal is received according to a polarization frequency reuse scheme, in which the composite signal occupies one of a plurality of polarization components. A correlation module correlates the one polarization component with another one of the plurality of polarization components. Further, a polarization cancellation module cancels the other polarization component. This approach advantageously enhances spectral efficiency, and hence system capacity.

According to one aspect of the present invention, a method for communicating in a radio communication system is disclosed. The method includes receiving a composite signal including an inbound signal and an outbound signal. Additionally, the method includes extracting the inbound signal from the composite signal by compensating for a non-linear effect associated with the composite signal.

According to another aspect of the present invention, a system for communicating in a radio communication system is disclosed. The system includes a receiver circuit configured to receive a composite signal including an inbound signal and an outbound signal. The system also includes a cancellation module configured to extract the inbound signal from the composite signal by compensating for a non-linear effect associated with the composite signal.

According to another aspect of the present invention, a device for communicating in a radio communication system is disclosed. The device includes means for receiving a composite signal including an inbound signal and an outbound signal, and means for extracting the inbound signal from the composite signal by compensating for a non-linear effect associated with the composite signal.

According to another aspect of the present invention, a computer-readable medium carrying one or more sequences of one or more instructions for communicating in a radio communication system is disclosed. When executed by one or more processors, the instructions cause the one or more processors to perform the step of receiving a composite signal including an inbound signal and an outbound signal, and extracting the inbound signal from the composite signal by compensating for a non-linear effect associated with the composite signal.

According to another aspect of the present invention, a method for communicating in a radio communication system including a terminal and a hub station is disclosed. The method includes receiving an inbound signal from the terminal and an outbound signal from the hub station. The method also includes transmitting a composite signal including the inbound signal and the outbound signal to the hub station, wherein the station extracts the inbound signal from the composite signal by compensating for a non-linear effect associated with the composite signal.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a radio communication system capable of relaying signals using an overlay of an inbound signal with an outbound signal, according to an embodiment of the present invention;

FIGS. 2A and 2B are graphs showing exemplary non-linear characteristics of an amplifier used in the system of FIG. 1;

FIG. 3 is a diagram of a system for compensating for non-linearity and filter delay associated with a communication channel carrying overlay signals, according to an embodiment of the present invention;

FIG. 4 is a flowchart of a process for interference cancellation by the system of FIG. 3;

FIG. 5 is a diagram of a system for compensating for non-linearity of a received composite signal and filter delay of a reference outbound signal associated with a communication channel carrying overlay signals, according to an embodiment of the present invention;

FIG. 6 is a flowchart of a process for interference cancellation by the system of FIG. 5;

FIG. 7 is a diagram of a satellite repeater arrangement associated with a polarization frequency reuse scheme deployed in the system of FIG. 1;

FIG. 8 is a diagram of a cross-polarization mechanism for removing cross-polarization degradation, according to an embodiment of the present invention;

FIG. 9 is a diagram of a system for canceling an outbound signal and cross-polarization, according to an embodiment of the present invention;

FIG. 10 is a flowchart of a process for interference cancellation by the system of FIG. 9;

FIG. 11 is a diagram of a computer system that can perform signal compensation, in accordance with an embodiment of the present invention; and

FIG. 12 is a diagram of a conventional satellite system in which inbound and outbound signals utilize unique frequency assignments.

### DESCRIPTION OF THE PREFERRED EMBODIMENT

A system, method, device, and software for generating an output signal representative of an inbound signal from a composite signal, which is received over a non-linear communication channel and represents an overlay of the inbound signal and an outbound signal, are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although embodiments of the present invention are explained with respect to a satellite communication system, it is recognized that the present invention can be practiced in any type of radio communication system, including a microwave systems, cellular systems, packet radio networks, etc.

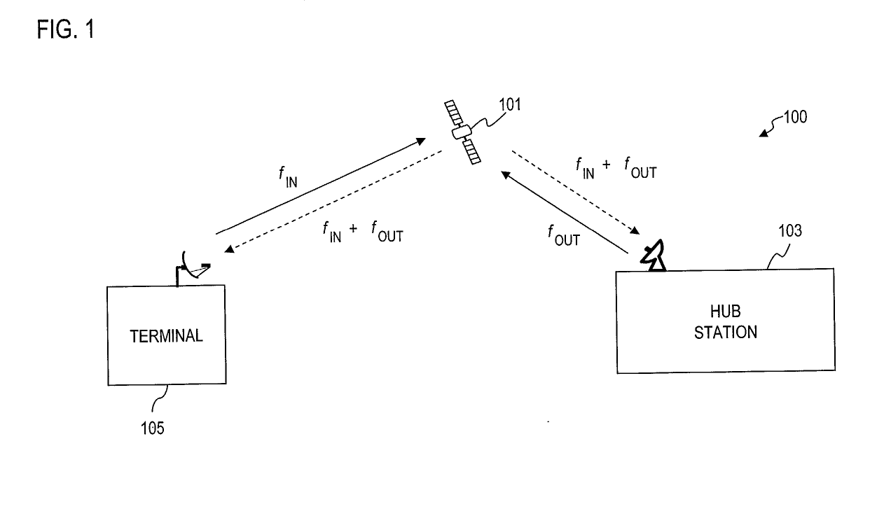

FIG. 1 is a diagram of a radio communication system capable of relaying signals using an overlay of an inbound signal with an outbound signal, according to an embodiment of the present invention. A radio communication system 100 includes a relay station 101 for relaying signals from a hub station 103 to a terminal 105 (i.e., outbound signals) and signals from the terminal 105 to the hub station 103 (i.e., inbound signals) for supporting two-way communication. In an exemplary embodiment, the relay station 101 is a satellite with multiple transponders, and the terminal 105 is a Very Small Aperture Terminal (VSAT) in support of data communication services.

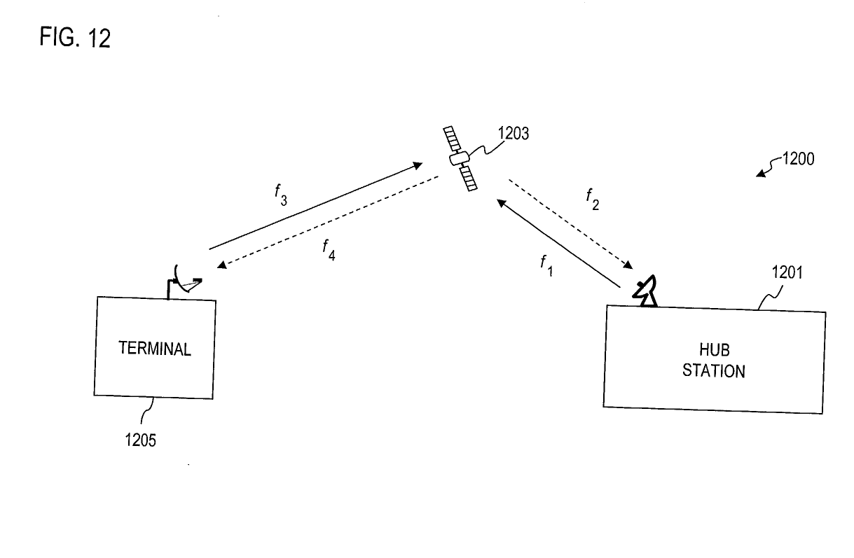

Unlike the conventional system of FIG. 12, the system 100 employs fewer frequencies to communicate between the terminal 105 and the hub station 103. As shown, the hub station 103 transmits outbound signals at frequency, ƒ_{OUT}; likewise, the terminal 105 sends inbound signals at frequency, ƒ_{IN}. It is observed that the outbound signal as received by the satellite 101 can be hundreds or even thousands time stronger than those of an individual inbound signal. The relay station 101 forwards a composite signal that includes an overlay of the inbound signal and the outbound signal to both the hub station 103 and the terminal 105.

The hub station 103 may send a relatively wide band signal to the relay station 101 (e,g., repeater) that further relays the signal to multiple terminals—only one of which is shown (terminal 105). The terminal 105 can send its own signals (i.e., inbound signals) to another repeater (not shown), or the same repeater 101 at a different part of the frequency band; and the repeater 101 relays the signal back to the hub station 103 individually. As noted, the repeater 101 can be a satellite transponder.

In the system 100, the capabilities of the hub station 103 and the remote terminals 105 can be quite different. For instance, the transmission power and the antenna sizes of the remote stations 105 can be far less capable than those of the hub station 103, as to minimize the overall network cost.

The performance of the inbound signals from the terminal 105 depends, in part, on the extent to which the outbound interference can be cancelled. In practical systems, the outbound signal can be hundreds or even thousands times stronger than the inbound signals. Therfore, even if large percentage (e.g., 99%) of the outbound signal can be cancelled, the inbound signal can still experience significant amount of residual interference. Such residual interference can degrade the performance of the inbound signals significantly or limit their throughput. Accurate interference cancellation depends critically on how the channel impairments (e.g., thermal noise, adverse atmospheric conditions, etc.) are being compensated. A dominant cause of impairments is the non-linearity of the channel, which may stem from the non-linear behavior of the satellite transponder.

The system 100 improves efficiency of spectral utilization by exploiting the power difference between the inbound signal and the outbound signal; this difference in power is sufficiently large such that the interference by the inbound signals to the outbound signal is assumed to be negligible. As a result, the interference caused by the remote terminals to the outbound signal is very small. Thus, the terminal 105 can demodulate and decode the outbound signal without additional processing. Interference cancellation is used at the hub station 103 to recover the weak inbound signals. Specifically, the inbound signals are recovered by subtracting a “reconstructed” outbound signal from the composite received signal, according to the following equation:

ƒ_{C}=ƒ_{IN}+ƒ_{OUT}

ƒ_{IN}=ƒ_{C}−ƒ_{OUT}

One approach to obtaining the inbound signal from the composite signal, in which the composite signal is generated by a linear amplifier, is described in commonly assigned U.S. Pat. No. 5,625,640 to Palmer et al, which is incorporated herein by reference in its entirety.

In the example of FIG. 1, it is assumed that the satellite transponders are non-linear repeaters. As a result, the non-linearity of the communications channel presents additional challenges over the system described in U.S. Pat. No. 5,625,640. With the system 100, the inbound signal from the terminal 105 can utilize any modulation, coding format (with or without spectrum spreading), whereas conventional approaches generally rely on the spread-spectrum nature of inbound signals to suppress any non-linear effect. Thus, the interference cancelation mechanism of the system 100 can be implemented without spectrum spreading. Additionally, traditional systems fail to adequately address the effect of the non-linearity in the repeater, providing no solution to counteract the degradation caused by such non-linerity. Further, the conventional systems do not account for the effect of cross-polarization degradation (such as during rain fades), in which the same frequency spectrum is reused by both polarization orientations.

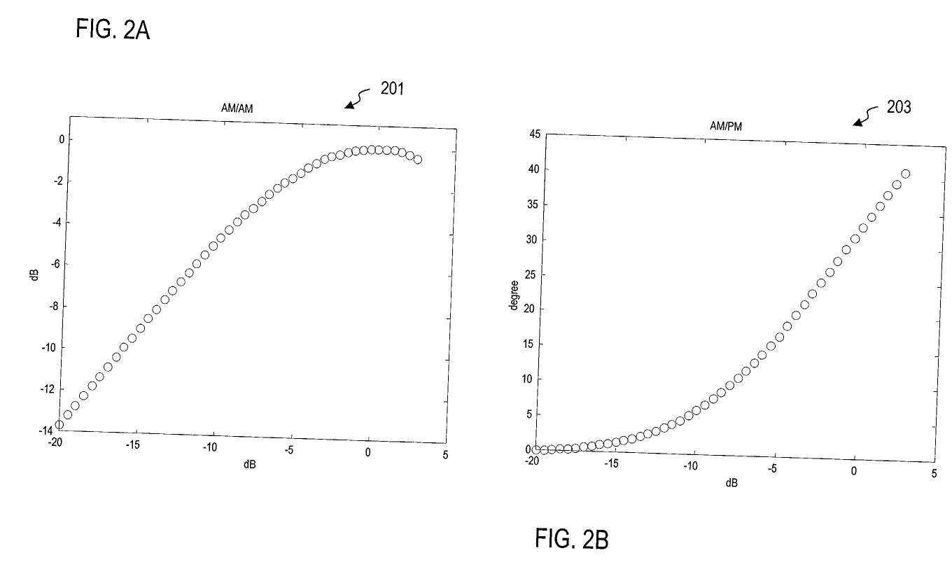

According to one embodiment of the present invention, power amplifiers utilized in the transponders of the satellite 101 exhibit non-linear characteristics described below in FIGS. 2A and 2B.

FIGS. 2A and 2B are graphs showing exemplary non-linear characteristics of an amplifier used in the system of FIG. 1. To achieve high power efficiency, the power amplifier in the repeater 101 is driven near saturation by the outbound signal. Unfortunately, operating near saturation yields non-linear behavior, in terms of amplitude and phase, as shown in graphs 201, 203, respectively. The non-linearity can be described by the AM/AM and AM/PM conversion functions of the power amplifier. The graphs 201, 203 show characteristics of a practical Traveling Wave Tube amplifier AM/AM and AM/PM conversion functions often used by satellite communications. It is clear that these functions are not linear when the amplifier is operated close to saturation point of the AM/AM conversion function. With respect to the graph 201, the amplitude behaves non-linearly above −5 dB; as regards the phase, from below −10 dB, the amplifier operates non-linearly. These non-linear characteristics of the power amplifier are a major impairment for accurate cancellation.

Non-linearity can cause intermodulation distortion when multiple signals are sent through the same power amplifier. Additionally, weaker signals are suppressed when they are amplified along with a much stronger signal. Depending on the number of inbound signals overlaid with the outbound signal, and how close to saturation the amplifiers are operated at, the residual interference can be at about the same level of thermal noise floor due to imperfect cancellation. As discussed previously, conventionally, spread spectrum inbound signals were deployed to address this cancellation challenge; however, these impairments were suppressed at the expense of overall capacity. That is, such impairments would be more severe if the inbound signals are TDMA-based instead of CDMA-based.

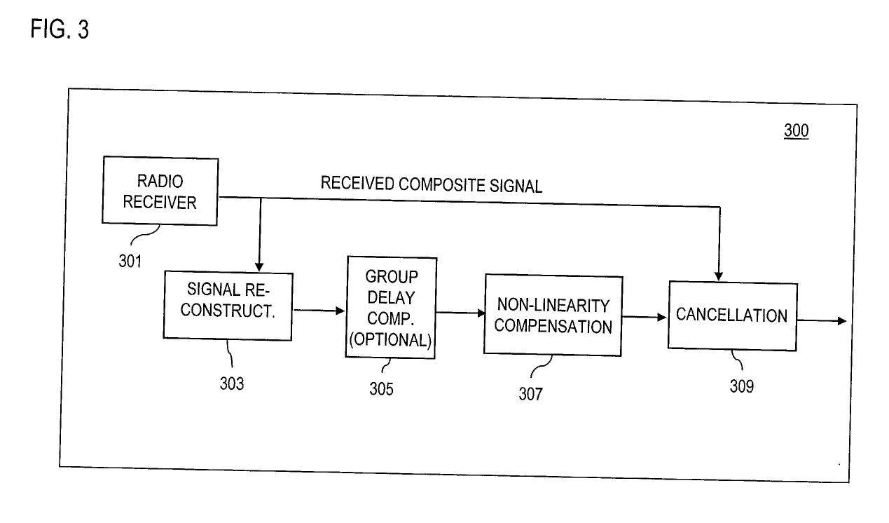

FIG. 3 is a diagram of a system for compensating for non-linearity and filter delay associated with a communication channel carrying overlay signals, according to an embodiment of the present invention. Receiver circuitry 300, in an exemplary embodiment, is deployed in the hub station 103 (FIG. 1) and extracts an inbound signal or multiple inbound signals from a composite signal received from the relay station 101. Conceptually, the received signal is sent through a “model” that emulates the repeater non-linearity and the group delay of the noise-limiting filter.

The receiver circuitry 300 includes a radio receiver 301 for receiving the composite signal. To cancel the outbound signal from the composite received signal, the receiver 301 at the hub station 103 needs to know what is transmitted from the hub station 103 as a reference. Because the outbound signal is stronger than the inbound signals, the receiver 301 can demodulate the composite signal and then, in an exemplary embodiment, reconstruct the reference signal. According to one embodiment of the present invention, a reference outbound signal is regenerated from the composite signal by a signal reconstruction module 303. Alternatively, the outbound signal can be buffered at the hub station 103 to serve as the reference signal.

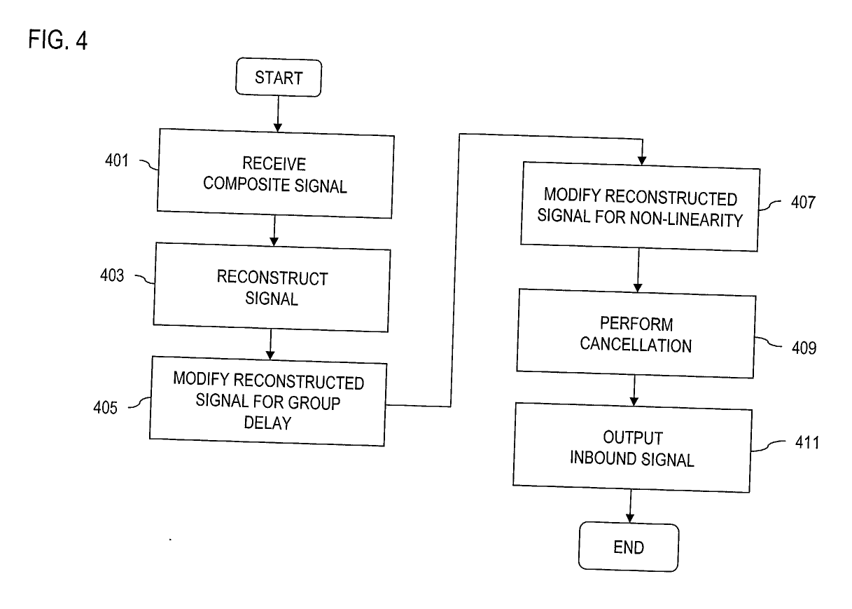

To achieve accurate interference cancellation, the reconstructed outbound signal is passed through an optional group delay compensation module 305 and then a non-linearity compensation module 307. The resultant modified reconstructed signal is then input to an interference cancellation module 309, which outputs the inbound signal. Although the modules 305, 307, 309 are described with respect to individual functionalities, it is recognized that any combination of the modules may implemented collectively or individually in hardware (e.g., Field Programmable Gate Array (FPGA)) and/or software. The generation of the inbound signal is more fully described below with respect to FIG. 4.

FIG. 4 is a flowchart of a process for interference cancellation by the system of FIG. 3. In step 401, the composite signal from the satellite 101 is received by the radio receiver 301. Next, the composite signal is fed, as in step 403, to the signal reconstruction module 303 to reconstruct the outbound signal, which serves as a reference signal. According to one embodiment of the present invention, the reference signal is modified for filter group delay, per step 405. Because group delay is a linear process, compensation can be performed by passing the reference signal through a pre-calibrated or adaptive learning group delay model.

Next, in step 407, the reference signal is further modified by compensating for the non-linearity. The non-linearity of the communication channel can be determined from pre-measurements of the non-linear effects or from the received composite signal through an adaptive learning process. If the non-linearity of the communication channel varies from repeater to repeater and over time, the adaptive learning approach may be preferable over the pre-measured approach. Further, when adaptive learning is used, the reference outbound signal can be optionally used to speed up the convergence. It is noted that the learning can be accomplished by curve fitting to the general characteristics of a non-linear repeater model, or by minimum mean squared estimation.

In step 409, the reference outbound signal after such processing is then used for interference cancellation. Because the key channel impairments of non-linearity and optionally the group delay are reproduced in the reference output signal, accurate interference cancellation can be achieved by the interference cancellation module 309.

The cancellation module 309, in an exemplary embodiment, matches the reference signal with the composite signal from the satellite 101 in terms of gain, timing, phase and frequency offset. An alternative implementation that does need to match the timing, phase and frequency offset is also possible. This implementation takes the difference between the baseband output of the demodulator and the remodulated signal with properly matched gain. In the case of self-adaptive repeater non-linearity modeling, such synchronization can similarly be obtained before the cancellation module 309. Alternatively, it can be a separate unit such that both the cancellation and the adaptive learning unit can share the synchronization information. Based on the received composite signal and the modified reference signal, the interference cancellation module 309 outputs the inbound signal, per step 411.

According to another embodiment of the present invention, the interference cancellation can be performed by processing the composite signal in addition to the reconstructed reference outbound signal, as described below.

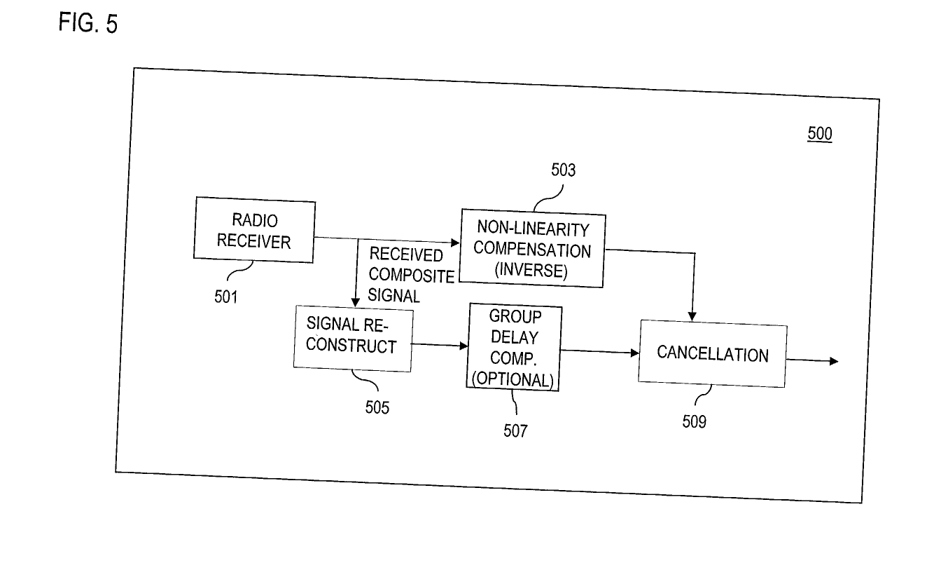

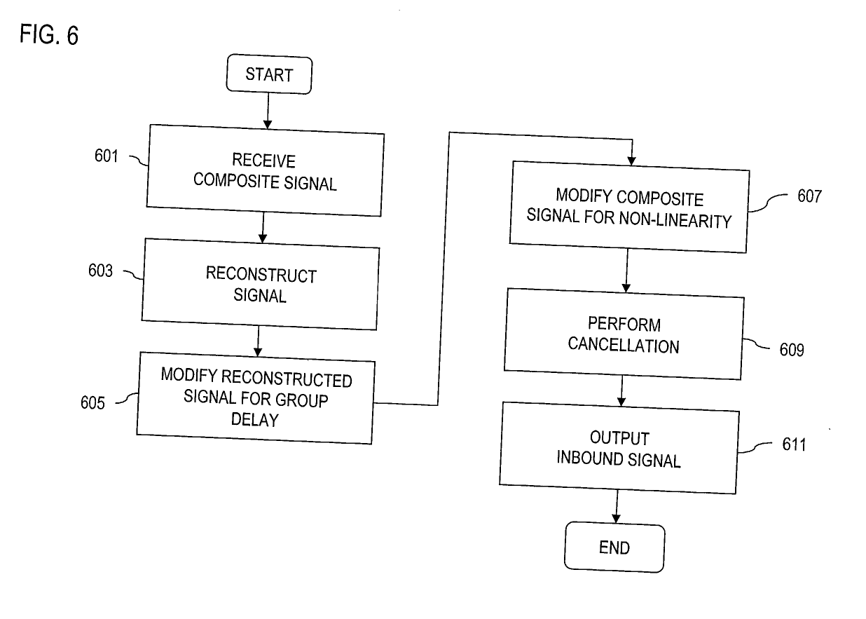

FIG. 5 is a diagram of a system for compensating for non-linearity of a received composite signal and filter delay of a reference outbound signal associated with a communication channel carrying overlay signals, according to an embodiment of the present invention. A receiver circuitry 500 includes a radio receiver 501 that receives a composite signal from the satellite 101 and extracts a component of the composite signal, namely the inbound signal. Unlike the circuitry 300 of FIG. 3, the circuitry 500 utilizes a non-linearity compensation module 503 that modifies the received composite signal to adjust for the nonlinearity of the communication channel (i.e., effectively applies an inverse function to the composite signal). The received composite signal, as in the receiver circuitry 300, is input to a signal reconstruction module 505, which reconstructs the outbound signal to provide a reference signal. The reconstructed outbound signal is then processed by an optional group delay compensation module 507 and presented to an interference cancellation module 509. The process by which the receiver circuitry 500 generates the inbound signal from the composite signal is more fully described below with respect to FIG. 6.

FIG. 6 is a flowchart of a process for interference cancellation by the system of FIG. 5. The receiver circuitry 500 compensates the impairment caused by the repeater amplifier non-linearity by modifying both the reference signal and the composite signal. In step 601, the receiver 501 receives a composite signal forwarded by the satellite 101. In step 603, the received composite signal is used to generate a reconstructed outbound signal, which is then modified for group delay, per step 605. The reference outbound signal can be generated based on the composite received signal from the satellite 101 or by buffering the transmitted signal at the hub station 103.

In step 607, the composite signal is modified for the non-linearity by effectively applying an inverse function. Instead of applying non-linear compensation to the reference signal, the non-linearity is compensated by applying a compensation device on the received composite signal. That is, if the satellite non-linearity is pre-measured, the non-linear compensation essentially performs the inverse function of the repeater non-linearity. In step 609, cancellation of the modified reference signal from the received composite signal is performed to yield the inbound signal (per step 611).

The above approach takes advantage of the fact that the downlink noise is relatively insignificant when compared with the non-linearity. Similar to the circuitry 300 of FIG. 3, prior knowledge of the non-linearity is not essential, as adaptive learning of the non-linearity (or inverse) can be employed. This approach provides accurate cancellation of interference by accounting for the non-linearity of the communications channel.

In highly efficient systems, a polarization scheme is utilized to increase system capacity; however, such a scheme may negatively impact the signal overlay techniques of FIGS. 4 and 6. Particularly, it is observed that degradation of cross-polarization during rain fade can be problematic when both polarizations of the same frequency spectrum are being used. As a result, cross-polarization cancellation is implemented, as discussed below. At the outset, it is instructive to describe the concept of polarization frequency reuse.

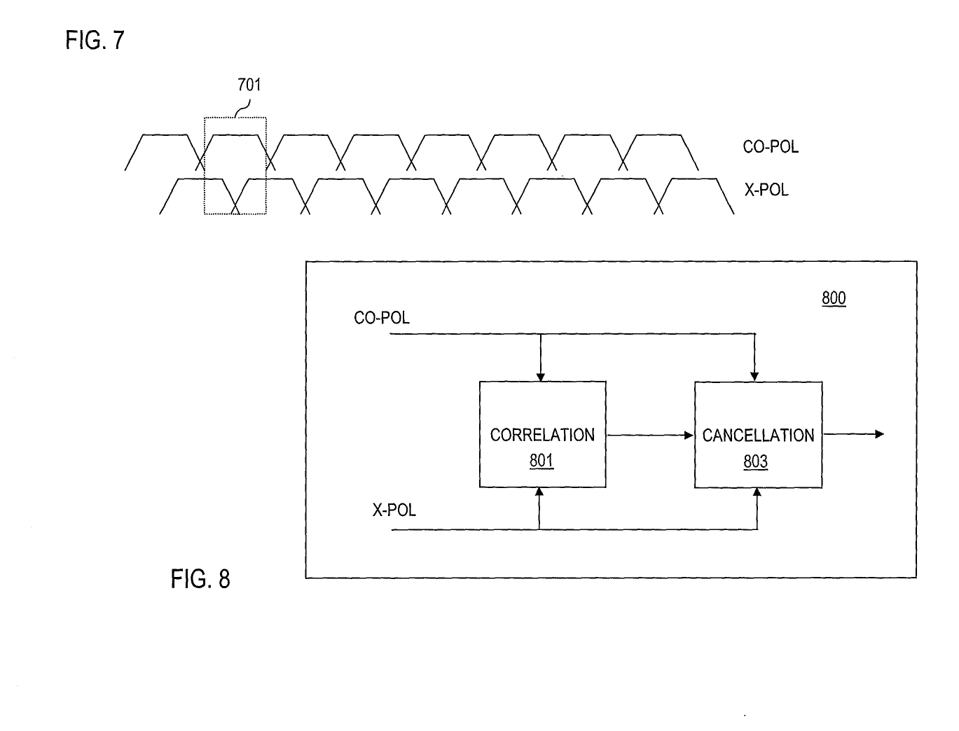

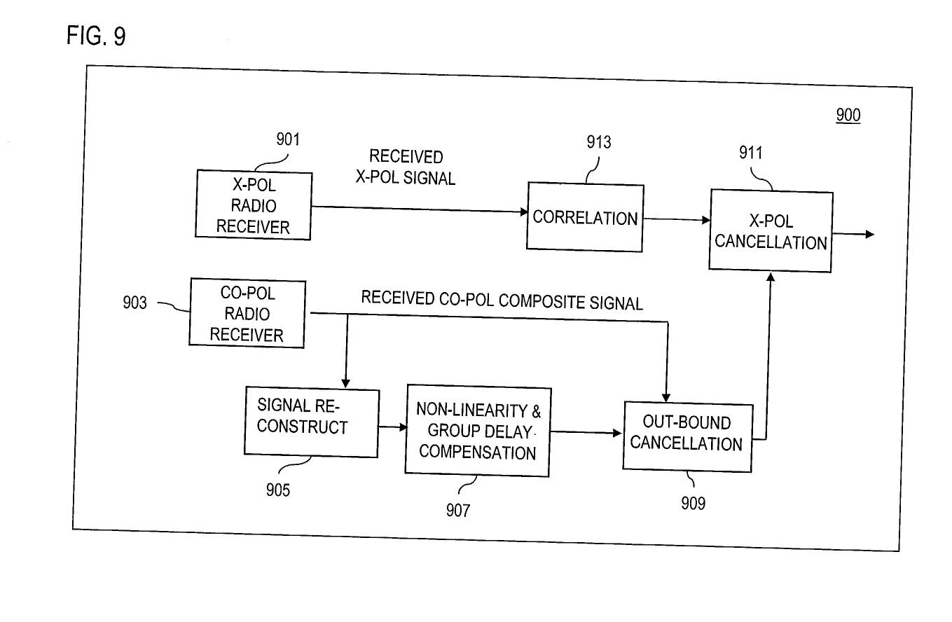

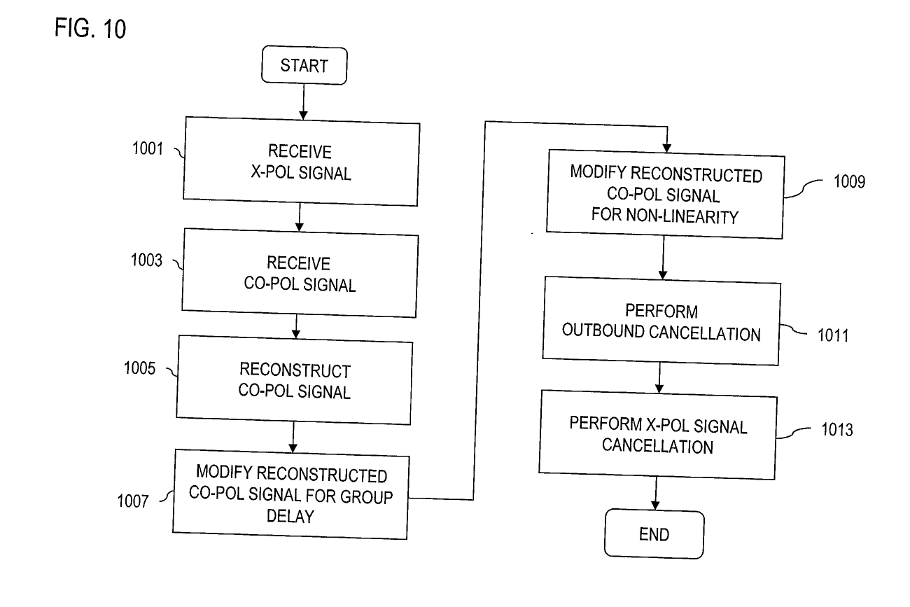

FIG. 7 is a diagram of a satellite repeater arrangement associated with a polarization frequency reuse scheme deployed in the system of FIG. 1. In the scheme illustrated in FIG.7, the signals between the cross-polarization are offset by half of the band. It is noted that such a scheme is but one embodiment, and thus, is not a requirement for the system of FIG. 1. In fact, this scheme is transparent to the spectrum arrangement of the cross-polarization. It is observed that even though the cross-polarization performance between the two polarizations may be deemed acceptable, satellite systems generally pair high-power full transponder outbound signals on the two polarizations to minimize the impact of cross-polarization degradation from a high-power carrier to a much smaller signal. But, when smaller inbound signals are sharing the spectrum with the outbound signal, the cross-polarization component from the high-power carrier of the opposite polarization can be as strong, or even stronger than the inbound signals, causing unacceptable performance degradation. This performance degradation can be overcome by incorporating a cross-polarization cancellation scheme into the outbound cancellation approach of FIGS. 4 and 6; this combined approach is more fully described with respect to FIGS. 9 and 10.

As seen in FIG. 7, the usable frequency band is divided up into separate transponders in each polarization, with their center frequency offset by half of the channel spacing between two adjacent transponders in the same polarization. For the purposes of explanation, the polarization of current interest is denoted as “Co-pol,” whereas the opposite polarization is denoted as “X-pol”. A highlighted dashed box 701 indicates the repeater of interest. To cancel the X-pol, a separate receiver from a receiver of the Co-pol is used to receive the signal in the X-pol for the corresponding band of interest as well. When the repeater bands are arranged in offset manner as shown, this receiver associated with the X-pol is tuned to receive half of the band from each of the two corresponding repeaters in the cross-polarization. The cross-polarization signal is cancelled by first correlating the X-pol and Co-pol signals, as explained below.

FIG. 8 is a diagram of a cross-polarization mechanism for removing cross-polarization degradation, according to an embodiment of the present invention. Under this approach, it is assumed that the hub station 103 receives the opposite polarization at the same frequency band of the signal of interest. A X-pol cancellation circuit 800 can be implemented in a receiver of the hub station 103 to provide cancellation of the X-pol signal. A received polarized signal from the satellite 101 is input into a correlation module 801, which determines the amount of power the Co-pol signal has transferred to the X-pol at a particular time. According to an embodiment of the present invention, through a look up table, the amount of interference power in the Co-pol due to the X-pol is determined.

Through a cancellation module 803, a scaled version of the X-pol signal is then subtracted from the Co-pol to facilitate the cancellation. The cross-polarization cancellation scheme can be integrated with the outbound signal cancellation scheme, as next discussed.

FIG. 9 is a diagram of a system for canceling an outbound signal and cross-polarization, according to an embodiment of the present invention. In this embodiment of the present invention, a receiver circuitry 900 provides an X-pol radio receiver 901 and a Co-pol radio receiver 903 for receiving, respectively, an X-pol signal and a Co-pol signal (which represents the composite signal).

FIG. 10 is a flowchart of a process for interference cancellation by the system of FIG. 9. In steps 1001 and 1003, the X-pol receiver 901 receives an X-pol signal, and the Co-pol receiver 903 receives the Co-pol signal. Similar to the circuitry 300 of FIG. 3, the received Co-pol composite signal is fed to a signal reconstruction module 905, which generates a reference outbound signal, per step 1005. The reference outbound signal is then modified, as in steps 1007 and 1009, by a repeater non-linearity and group delay compensation module 907 (which may be implemented as two separate modules, as shown in FIG. 3).

The modified reference outbound signal is used by an outbound cancellation module 909 to remove the corresponding component from the composite signal, per step 1011. The cancellation module 909 outputs an inbound signal to a X-pol cancellation module 911, which effectively removes the interference from the X-pol signal.

The received X-pol signal input to a correlation module 913 to determine the amount of power transferred to the Co-pol signal. Next, the X-pol cancellation module 911 cancels the interference from the X-pol signal; as noted, this cross-polarization interference may stem from rain fades. In the above approach, the X-pol interference is subtracted out after the outbound signal is first cancelled out. It is noted that the modules 905, 907, 909, 911, 913 can be combined in any combination to perform the corresponding functions.

Although the above process is described with respect to FIG. 9, this process can alternatively be performed by combining the receiver system of FIG. 5 and the X-pol cancellation module of FIG. 8.

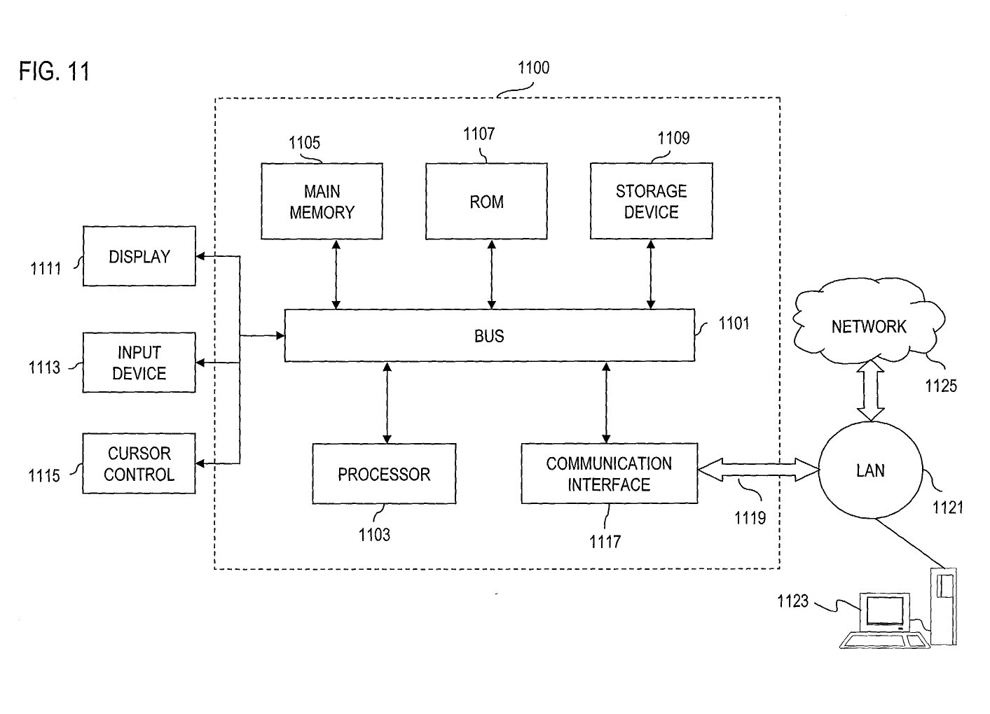

FIG. 11 illustrates a computer system 1100 upon which an embodiment according to the present invention can be implemented. The computer system 1100 includes a bus 1101 or other communication mechanism for communicating information, and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions to be executed by the processor 1103. The computer system 1100 further includes a read only memory (ROM) 1107 or other static storage device coupled to the bus 1101 for storing static information and instructions for the processor 1103. A storage device 1109, such as a magnetic disk or optical disk, is additionally coupled to the bus 1101 for storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is cursor control 1115, such as a mouse, a trackball, or cursor direction keys for communicating direction information and command selections to the processor 1103 and for controlling cursor movement on the display 1111.

According to one embodiment of the invention, the processes of FIGS. 4, 6, and 10 provided by the computer system 1100 in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the present invention. Thus, embodiments of the present invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, or a telephone modem to provide a data communication connection to a corresponding type of telephone line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by service provider. The local network 1121 and network 1125 both use electrical, electromagnetic, or optical signals to convey information and instructions. The signals through the various networks and the signals on network link 1119 and through communication interface 1117, which communicate digital data with computer system 1100, are exemplary forms of carrier waves bearing the information and instructions.

The computer system 1100 can send messages and receive data, including program code, through the network(s), network link 1119, and communication interface 1117. In the Internet example, a server (not shown) might transmit requested code belonging to an application program for implementing an embodiment of the present invention through the network 1125, local network 1121 and communication interface 1117. The processor 1104 may execute the transmitted code while being received and/or store the code in storage device 119, or other non-volatile storage for later execution. In this manner, computer system 1100 may obtain application code in the form of a carrier wave.

The term “computer-readable medium” as used herein refers to any medium that participates in providing instructions to the processor 1104 for execution. Such a medium may take many forms, including but not limited to non-volatile media, volatile media, and transmission media. Non-volatile media include, for example, optical or magnetic disks, such as storage device 1109. Volatile media include dynamic memory, such as main memory 1105. Transmission media include coaxial cables, copper wire and fiber optics, including the wires that comprise bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, an approach is provided for extracting an inbound signal from a composite signal that includes the inbound signal overlaid with an outbound signal. A non-linearity compensation module determines the non-linear effect based on one of a pre-measurement of the non-linear effect and an adaptively learning the non-linear effect from the received composite signal. According to one embodiment of the present invention, the non-linearity compensation module modifies the reference signal based on the determined non-linear effect, and a group delay compensation module also modifies the reference signal for filter delay of the composite signal. Alternatively, the non-linearity compensation module can perform an inverse function to modify the composite signal based on the determined non-linear effect. In another embodiment of the present invention, the composite signal is received according to a polarization frequency reuse scheme, in which the composite signal occupies one of a plurality of polarization components. A correlation module correlates the one polarization component with another one of the plurality of polarization components. Further, a polarization cancellation module cancels the other polarization component. This approach advantageously enhances spectral efficiency, and hence system capacity.

While the present invention has been described in connection with a number of embodiments and implementations, the present invention is not so limited but covers various obvious modifications and equivalent arrangements, which fall within the purview of the appended claims.

What is claimed is:

1. A method for communicating in a radio communication system, the method comprising:
receiving a composite signal including an inbound signal and an outbound signal; and
extracting the inbound signal from the composite signal by compensating for a non-linear effect associated with the composite signal.

2. A method according to claim 1, further comprising:
determining the non-linear effect based on at least one of a pre-measurement of the non-linear effect and the received composite signal.

3. A method according to claim 2, further comprising:
adaptively learning the non-linear effect based on the received composite signal.

4. A method according to claim 3, wherein the learning step is performed according to at least one of curve fitting estimation and minimum mean squared estimation.

5. A method according to claim 2, further comprising:
generating a reference signal representing the outbound signal.

6. A method according to claim 5, further comprising:
buffering the outbound signal, wherein the outbound signal is used as the reference signal.

7. A method according to claim 5, further comprising:
modifying the reference signal based on the determined non-linear effect;
selectively further modifying the reference signal for filter delay of the composite signal; and canceling the modified reference signal from the composite signal.

8. A method according to claim 2, further comprising:
matching a plurality of parameters associated with the reference signal to that of the composite signal, wherein the plurality of parameters include at least one of gain, timing, phase, and frequency.

9. A method according to claim 2, further comprising:
selectively modifying the reference signal for filter delay of the composite signal; and
modifying the composite signal based on the determined non-linear effect; and
canceling the modified reference signal from the modified composite signal.

10. A method according to claim 1, wherein the radio communication system includes a terminal in communication with a hub station over a satellite.

11. A method according to claim 1, wherein the composite signal is received according to a polarization frequency reuse scheme, and the composite signal occupies one of a plurality of polarization components, the method further comprising:
correlating the one polarization component with another one of the plurality of polarization components; and
canceling the other polarization component.

12. A system for communicating in a radio communication system, the system comprising:
a receiver circuit configured to receive a composite signal including an inbound signal and an outbound signal; and
a cancellation module configured to extract the inbound signal from the composite signal by compensating for a non-linear effect associated with the composite signal.

13. A system according to claim 12, further comprising:
a non-linearity compensation module configured to determine the non-linear effect based on at least one of a pre-measurement of the non-linear effect and the received composite signal.

14. A system according to claim 13, wherein the non-linearity compensation module determines the non-linear effect by adaptively learning the non-linear effect based on the received composite signal.

15. A system according to claim 14, wherein the non-linearity compensation module adaptively learns according to at least one of curve fitting estimation and minimum mean squared estimation.

16. A system according to claim 13, further comprising:
a signal reconstruction module configured to generate a reference signal representing the outbound signal.

17. A system according to claim 16, further comprising:
memory configured to store the outbound signal, wherein the outbound signal is used as the reference signal.

18. A system according to claim 16, further comprising:
a non-linearity compensation module configured to modify the reference signal based on the determined non-linear effect.

19. A system according to claim 18, further comprising:
a group delay compensation module configured to modify the reference signal for filter delay of the composite signal.

20. A system according to claim 13, wherein the non-linearity compensation module is further configured to match a plurality of parameters associated with the reference signal to that of the composite signal, wherein the plurality of parameters include at least one of gain, timing, phase, and frequency.

21. A system according to claim 13, further comprising:
a non-linearity compensation module configured to modify the composite signal based on the determined non-linear effect.

22. A system according to claim 21, further comprising:
a group delay compensation module configured to modify the reference signal for filter delay of the composite signal.

23. A system according to claim 12, wherein the radio communication system includes a terminal in communication with a hub station over a satellite.

24. A system according to claim 12, wherein the composite signal is received according to a polarization frequency reuse scheme, and the composite signal occupies one of a plurality of polarization components, the system further comprising:
a correlation module configured to correlate the one polarization component with another one of the plurality of polarization components; and
a polarization cancellation module configured to cancel the other polarization component.

25. A device for communicating in a radio communication system, the device comprising:
means for receiving a composite signal including an inbound signal and an outbound signal; and
means for extracting the inbound signal from the composite signal by compensating for a non-linear effect associated with the composite signal.

26. A device according to claim 25, further comprising:
means for determining the non-linear effect based on at least one of a pre-measurement of the non-linear effect and the received composite signal.

27. A device according to claim 26, wherein the determining means determines the non-linear effect by adaptively learning the non-linear effect based on the received composite signal.

28. A device according to claim 27, wherein the determining means adaptively learns according to at least one of curve fitting estimation and minimum mean squared estimation.

29. A device according to claim 26, further comprising:
means for generating a reference signal representing the outbound signal.

30. A device according to claim 29, further comprising:
means for buffering the outbound signal, wherein the outbound signal is used as the reference signal.

31. A device according to claim 29, further comprising:
means for modifying the reference signal based on the determined non-linear effect.

32. A device according to claim 31, further comprising:
means for modifying the reference signal for filter delay of the composite signal; and
means for canceling the modified reference signal from the composite signal.

33. A device according to claim 26, further comprising:
means for matching a plurality of parameters associated with the reference signal to that of the composite signal, wherein the plurality of parameters include at least one of gain, timing, phase, and frequency.

34. A device according to claim 26, further comprising:
means for modifying the composite signal based on the determined non-linear effect.

35. A device according to claim 34, further comprising:
means for modifying the reference signal for filter delay of the composite signal; and
means for canceling the modified reference signal from the modified composite signal.

36. A device according to claim 25, wherein the radio communication system includes a terminal in communication with a hub station over a satellite.

37. A device according to claim 25, wherein the composite signal is received according to a polarization frequency reuse scheme, and the composite signal occupies one of a plurality of polarization components, the device further comprising:
means for correlating the one polarization component with another one of the plurality of polarization components; and
means for canceling the other polarization component.

38. A computer-readable medium carrying one or more sequences of one or more instructions for communicating in a radio communication system, when executed by one or more processors, cause the one or more processors to perform the steps of:
receiving a composite signal including an inbound signal and an outbound signal; and
extracting the inbound signal from the composite signal by compensating for a non-linear effect associated with the composite signal.

39. A computer-readable medium according to claim 38, wherein the one or more processors further perform the step of:
determining the non-linear effect based on at least one of a pre-measurement of the non-linear effect and the received composite signal.

40. A computer-readable medium according to claim 39, wherein the one or more processors further perform the step of:
adaptively learning the non-linear effect based on the received composite signal.

41. A computer-readable medium according to claim 40, wherein the learning step is performed according to at least one of curve fitting estimation and minimum mean squared estimation.

42. A computer-readable medium according to claim 39, wherein the one or more processors further perform the step of:
generating a reference signal representing the outbound signal.

43. A computer-readable medium according to claim 42, wherein the one or more processors further perform the step of:
buffering the outbound signal, wherein the outbound signal is used as the reference signal.

44. A computer-readable medium according to claim 42, wherein the one or more processors further perform the steps of:
modifying the reference signal based on the determined non-linear effect;
selectively further modifying the reference signal for filter delay of the composite signal; and
canceling the modified reference signal from the composite signal.

45. A computer-readable medium according to claim 39, wherein the one or more processors further perform the step of:
matching a plurality of parameters associated with the reference signal to that of the composite signal, wherein the plurality of parameters include at least one of gain, timing, phase, and frequency.

46. A computer-readable medium according to claim 39, wherein the one or more processors further perform the steps of:
selectively modifying the reference signal for filter delay of the composite signal; and
modifying the composite signal based on the determined non-linear effect; and
canceling the modified reference signal from the modified composite signal.

47. A computer-readable medium according to claim 38, wherein the radio communication system includes a terminal in communication with a hub station over a satellite.

48. A computer-readable medium according to claim 38, wherein the composite signal is received according to a polarization frequency reuse scheme, and the composite signal occupies one of a plurality of polarization components, the one or more processors further performing the steps of:
correlating the one polarization component with another one of the plurality of polarization components; and
canceling the other polarization component.

49. A method for communicating in a radio communication system including a terminal and a hub station, the method comprising:
receiving an inbound signal from the terminal and an outbound signal from the hub station; and
transmitting a composite signal including the inbound signal and the outbound signal to the hub station, wherein the station extracts the inbound signal from the composite signal by compensating for a non-linear effect associated with the composite signal.

50. A method according to claim 49, wherein the hub station is configured to perform the step of:
determining the non-linear effect based on at least one of a pre-measurement of the non-linear effect and the received composite signal.

51. A method according to claim 50, wherein the hub station is configured to further perform the step of:
adaptively learning the non-linear effect based on the received composite signal.

52. A method according to claim 51, wherein the learning step is performed according to at least one of curve fitting estimation and minimum mean squared estimation.

53. A method according to claim 50, wherein the hub station is configured to perform the step of:
generating a reference signal representing the outbound signal.

54. A method according to claim 53, wherein the hub station is configured to perform the step of:
buffering the outbound signal, wherein the outbound signal is used as the reference signal.

55. A method according to claim 53, wherein the hub station is configured to perform the steps of:
modifying the reference signal based on the determined non-linear effect;
selectively further modifying the reference signal for filter delay of the composite signal; and
canceling the modified reference signal from the composite signal.

56. A method according to claim 50, wherein the hub station is configured to perform the step of:
matching a plurality of parameters associated with the reference signal to that of the composite signal, wherein the plurality of parameters include at least one of gain, timing, phase, and frequency.

57. A method according to claim 50, wherein the hub station is configured to perform the steps of:
selectively modifying the reference signal for filter delay of the composite signal; and
modifying the composite signal based on the determined non-linear effect; and
canceling the modified reference signal from the modified composite signal.

58. A method according to claim 49, wherein the composite signal is transmitted according to a polarization frequency reuse scheme, and the composite signal occupies one of a plurality of polarization components, the hub station being configured to perform the steps of:
correlating the one polarization component with another one of the plurality of polarization components; and
canceling the other polarization component.
